(19) United States
(12) Patent Application Publication
(10) Pub. No.: US 2013/0067553 A1
(43) Pub. Date: Mar. 14, 2013

(54) CONTROL APPARATUS AND METHOD FOR EXECUTING APPLICATION

(71) Applicants: Sang Guin OH, Seoul (KR); Jong Yeob KIM, Seoul (KR); Yeon Seon LEE, Seoul (KR)

(72) Inventors: Sang Guin OH, Seoul (KR); Jong Yeob KIM, Seoul (KR); Yeon Seon LEE, Seoul (KR)

(73) Assignee: PANTECH CO., LTD., Seoul (KR)

(21) Appl. No.: 13/368,788

(22) Filed: Feb. 8, 2012

(30) Foreign Application Priority Data
Sep. 9, 2011 (KR) 10-2011-0091997

(51) Int. Cl. G06F 21/20

(52) U.S. Cl. 726/7

(57) ABSTRACT

A mobile terminal to execute an operation of an application includes an application framework to determine a reliability level of the application, to assign a first secure key value to the operation, and to pack a second secure key value to an event packet generated by the application; and a modem layer to extract the second secure key value from the event packet, to determine whether the second secure key value corresponds to the first secure key value of the operation, and to determine whether to execute the operation. A method for executing an operation of an application includes assigning a first secure key value to the operation; receiving an event packet corresponding to the operation; extracting a second secure key value from the event packet; comparing the second secure key value with the first secure key value; and determining whether to execute the operation.

### CROSS-REFERENCE TO RELATED APPLICATION

This application claims priority from and the benefit of Korean Patent Application No. 10-2011-0091997, filed on Sep. 9, 2011, which is hereby incorporated by reference for all purposes as if fully set forth herein.

### BACKGROUND

1. Field

The following description relates to a control apparatus and method for executing an application in a mobile terminal.

2. Discussion of the Background

A mobile terminal, such as a smartphone or a mobile computing device (“smart device”), may accommodate a variety of applications to be installed in the mobile terminal.

If an application is executed, a corresponding service may be requested in relation to the executed application. In response to the service request by the executed application, an event associated with a corresponding service may be processed within the mobile terminal. If processing an application event, the mobile terminal may execute the requested service regardless of whether the corresponding application event is related to the executed application.

Therefore, since the mobile terminal may be unable to determine whether the corresponding application event is related to the execution of the application, an unintended or unauthorized operation may be performed. For example, unintended or unauthorized charges or usage of voice communication or a data communication, providing of personal information by a global positioning system (GPS), access of wireless fidelity (Wi-Fi) service, and the like may occur.

Depending on the executed application, unintended or unauthorized operation by the mobile terminal may be performed without user recognition and thus, damages, for example, invasion of privacy and/or unauthorized charges, may occur.

### SUMMARY

Exemplary embodiments of the present invention provide an apparatus and method for executing an operation of an application using a secure key value.

Additional features of the invention will be set forth in the description which follows, and in part will be apparent from the description, or may be learned by practice of the invention.

Exemplary embodiments of the present invention provide a mobile terminal to execute an operation of an application including an application layer to store the application; an application framework to determine a reliability level of the application, to assign a first secure key value to the operation, and to pack a second secure key value to an event packet generated by the application; and a modem layer to extract the second secure key value from the event packet, to determine whether the second secure key value corresponds to the first secure key value of the operation, and to determine whether to execute the operation.

Exemplary embodiments of the present invention provide a method for executing an operation of an application including assigning a first secure key value to the operation; receiving an event packet corresponding to the operation; extracting a second secure key value from the event packet; comparing the second secure key value with the first secure key value; and determining whether to execute the operation.

Exemplary embodiments of the present invention provide a method for installing an application including determining a type of the application; determining an operation of the application; determining a reliability level of the application; installing the application; assigning the operation to the application based on the reliability level; and assigning a first secure key value to the operation.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a mobile terminal according to an exemplary embodiment of the present invention.

FIG. 2 is a block diagram illustrating an application processing unit according to an exemplary embodiment of the present invention.

FIG. 3 is a block diagram illustrating a modem processing unit according to an exemplary embodiment of the present invention.

FIG. 4 is a flowchart illustrating a method for downloading an application according to an exemplary embodiment of the present invention.

FIG. 5 is a diagram illustrating an access right search result of an application according to an exemplary embodiment of the present invention.

FIG. 6 is a flowchart illustrating a method for generating a service request event in response to an execution of an application according to an exemplary embodiment of the present invention.

FIG. 7 is a flowchart illustrating a method for operating a modem processing unit according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present.

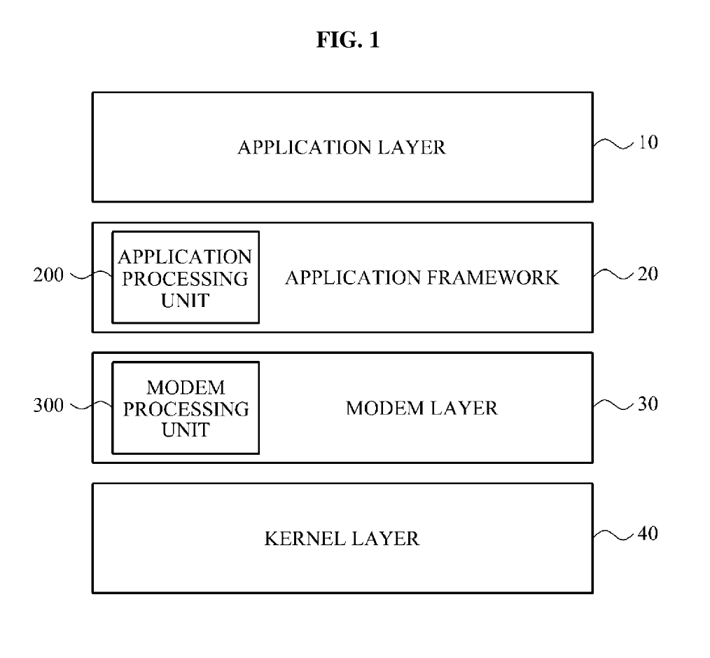

FIG. 1 is a diagram illustrating a mobile terminal according to an exemplary embodiment of the present invention.

Referring to FIG. 1, the mobile terminal may include an application layer 10, an application framework 20, a modem layer 30, and a kernel layer 40. The mobile terminal may include, without limitation, a smart cellphone or a smart mobile computing device.

The application layer 10 may provide general applications, which may include an application to provide a voice communication service, a data communication service, an email service, a global position system (GPS) service, and the like.

The application framework 20 may provide one or more components to support application configuration and/or operation. For example, the components provided by the application framework 20 may include at least one of an activity manager, a window manager, a content provider, a view system, a notification manager, a package manager, a telephony manager, a resource manager, a location manager, an extensible messaging and presence protocol (XMPP) service, and the like.

Further, the application framework 20 may also include an application processing unit 200. The application processing unit 200 may determine whether to install the application, determine reliability of the application to be installed, and may assign a secure key value to the application. More specifically, one or more secure key values may be assigned to one or more operations of the mobile terminal based on a reliability level of the application. In addition, the application processing unit 200 may determine reliability level of the application already installed in the mobile terminal and assign a secure key value to the application and/or one or more operations allowed by the application based on the reliability level.

The modem layer 30 may perform verification operations, such as verification of authorized access of the application to execute a reference operation. In addition, the modem layer 30 may also perform verification and processing of the secure key value that may be received from the application framework 20. More specifically, a modem processing unit 300 included in the modem layer 30 may verify the secure key value with respect to the application that is assigned, and may execute the application in response to a determination that the application has the appropriate secure key value. The secure key value may be assigned based on reliability or reliability level of the application.

The kernel layer 40 may manage one or more core system services associated with system or device memory, network communications, security operations, and one or more drivers.

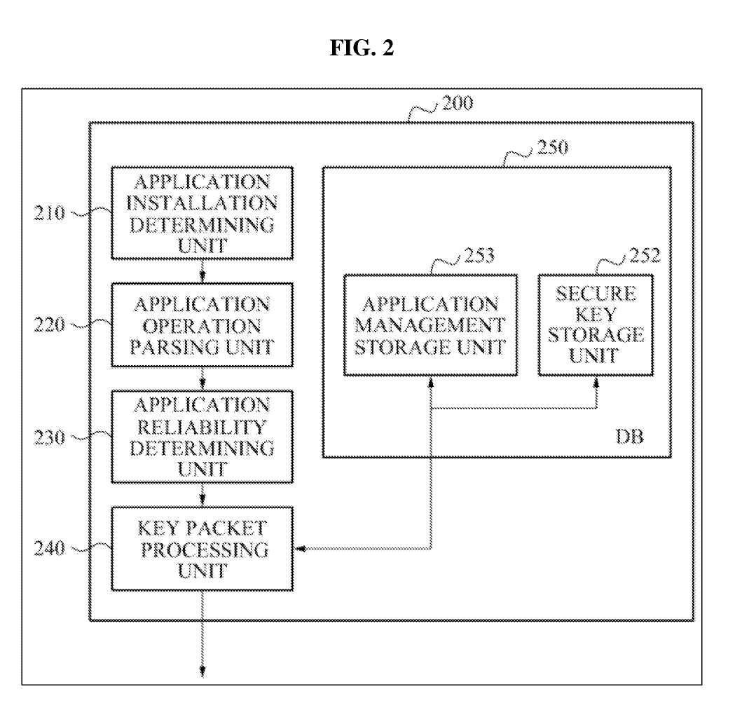

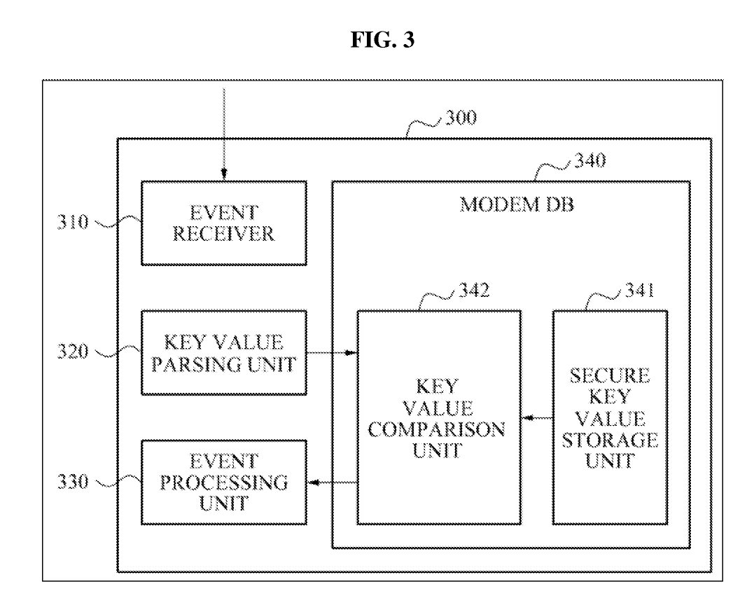

The application framework 20 and the modem layer 30 will be further described with reference to FIG. 2 and FIG. 3.

FIG. 2 is a block diagram illustrating an application processing unit according to is an exemplary embodiment of the present invention.

Referring to FIG. 2, the application processing unit 200, included in the application framework 20 of the mobile terminal, may include an application installation determining unit 210, an application operation parsing unit 220, an application reliability determining unit 230, a key value packet processing unit 240, and a database 250.

The application installation determining unit 210 may determine a type of an application. The application may be downloaded through a communication network or an external device, and may determine whether to install the downloaded application in the mobile terminal.

The application operation parsing unit 220 may parse or categorize an operation of an installed application. The application operation parsing unit 220 may parse information about type, operational characteristic, and operation of the downloaded application. Based on the parsed information, the application operation parsing unit 220 may determine and classify the operation associated with the application.

The application reliability determining unit 230 may determine reliability of the application based on the information parsed by the application operation parsing unit 220, and may set a reliability level. For example, if an operating system (OS) manufacturer produces a corresponding application, which may be installed with an OS, the application may be determined to be reliable or have a high reliability level. However, if a user downloads an application through an application store or an unknown third party websites, and the like, the application may be determined not to be reliable or have a low reliability level. Further, if the OS producer or a manufacturing company of the mobile terminal does not produce an application obtained by the user, the application may be determined to be unreliable or have a low reliability is level.

One or more operations that may be performed by a mobile terminal may be determined based on an application. For example, a first application may be set to use a voice communication operation and a data transmission operation using wireless fidelity (Wi-Fi) among the available operations of the mobile terminal. A second application may be set to use the voice communication operation and a GPS operation among the available operations of the mobile terminal. If the first application generates a GPS event in order to perform the GPS operation, the application processing unit 200 may ignore the GPS event and may not execute the GPS event since the first application is not set or authorized to use such an operation. Also, the application processing unit 200 may inform a user about the first application's attempt to perform an unset or unauthorized operation by the first application, and may receive a selection from the user about whether to allow the GPS operation to be performed by the first application.

Further, an operation that can be performed by an application may be determined based on its respective reliability level. For example, an application having a low reliability level may be limited to use a simple voice communication operation, whereas an application having a higher reliability level may additionally use a camera operation, and an application having an even higher reliability level may photograph a picture with a camera and transmit the photographed picture to a network using the camera operation and a data transmission operation.

More specifically, the application determined to be reliable or having a high reliability level may be authorized to use more operations available in the mobile terminal than an application determined to be unreliable or have a low reliability level. The application determined to be unreliable or have low reliability level may be authorized to use limited operations designated to the applications with low reliability level. Further, in some cases, the application determined to be unreliable or have a low reliability level may be denied the right to use any of the operations of the mobile terminal.

The database 250 may store information related to reliability level and/or a set of allowed operations of one or more applications. The key value packet processing unit 240 may determine whether to process an event or event packet (hereinafter, reference to an “event” may refer to an event or event packet) generated by an application based on a reliability level of an operation called by the respective application. In addition, the key value packet processing unit 240 may determine whether to process an event generated by an application based on the set of allowed operations associated with the respective application.

A secure key value may be set or assigned with respect to one or more operation of a mobile terminal, and the key value packet processing unit 240 may process an event of an application based on a reliability level of the respective application, and the assigned secure key value.

The key value processing unit 240 may determine whether an event generated by an application corresponds to a secure key value. If the event is determined to correspond to an appropriate secure key value, the key value packet processing unit 240 may load the secure key value from the database 250, and may process the event using the loaded secure key value.

The database 250 may include a secure key value storage unit 252 and an application management storage unit 253.

Table 1 shows an example of setting or assigning a secure key value according to an operation of an application stored in the secure key value storage unit 252. The following secure key values may also be stored in a storage unit of the modem processing unit 300.

TABLE 1

| Operation | Voice | SMS | MMS | Data | GPS | WIFI |
|---|---|---|---|---|---|---|
| Secure Key | K_{voice} | Kₛₘₛ | Kₘₘₛ | K_{data} | K_{gps} | K_{wifi} |
| value | | | | | | |

Table 1 shows an example of assigning secure key values to respective service items or operation according to an execution of the application. That is, a secure key value may be assigned according to a service or an operation being provided. For example, secure key value K_{voice} may be assigned to a voice service, and secure key value K_{gps} may be assigned to a GPS service.

Even though a different secure key value is assigned to each operation in FIG. 1, the same secure key value may be assigned to a plurality of operations. That is, an application assigned with a reference secure key value may be used to access a plurality of operations corresponding to the reference secure key value.

Further, a secure key value stored in the secure key value storage unit 252 may be classified or categorized based on an entity that allows a behavior of an application. More specifically, a determination of whether to allow an operation of the application may be manually selected by a user and set to be automatically performed in the mobile terminal. If the user allows the operation of the application by providing a user input, the mobile terminal may generate and set a secure key value for that operation.

If the mobile terminal automatically determines whether to allow the operation of the application, and if a reliability level of the application is greater than or equal to a reference or high level, the mobile terminal may be set to allow most or all operations of the application. If the reliability of the application is less than the reference or high level, the user may be is enabled to select whether to allow the operation of the application.

Table 2 shows an example of a key value table stored in the application management storage unit 253.

TABLE 2

| | Voice | SMS | MMS | Data | GPS | WIFI |
|---|---|---|---|---|---|---|
| APP1 | K_{voice} | | | | K_{gps} | |
| APP2 | | Kₛₘₛ | | | | K_{wifi} |
| APP3 | | | Kₘₘₛ | K_{data} | K_{gps} | |

As shown in Table 2, the application management storage unit 253 may store, in a table, a secure key value for one or more operations of an application, which may be assigned a secure key value. The key value stored in the application management storage unit 253 may correspond to a secure key value to be assigned to the corresponding application.

For example, if APP1 is executed, APP1 may be assigned with a secure key value with respect to a voice operation and a GPS operation. Like APP1, a secure key value according to each operation may be assigned to a corresponding application.

If a secure key value is assigned to an operation to be used by a corresponding application, the key value packet processing unit 240 may concatenate or pack an event generated by the application and a secure key value of the operation. The event concatenated or packed with the secure key value may be transmitted to the modem processing unit 300.

Referring to Table 2, a secure key value is set to the voice service or operation of APP1. If APP1 is to use the voice service or operation, APP1 may pack the secure key value and the event using the voice service and may transmit the packed event to the modem processing unit 300. The modem processing unit 300 may extract the secure key value from the packed event, and may determine whether the extracted secure key value matches the secure key value that is set with respect to the voice service. If the extracted secure key value matches the secure key value that is set with respect to the voice service, the modem processing unit 300 may process the event using the voice service and APP1 may use the voice service or operation.

A secure key value is not set to a short message service (SMS) and a multimedia messaging service (MMS) of APP1. Thus, an event generated by APP1 to use the SMS or the MMS may not be packed with the secure key value. The modem processing unit 300 may not extract the secure key value from the event since such value is not packed in the respective event. The modem processing unit 300 may not process the event for using the SMS service the MMS service since the secure key value is not provided.

Further, although not illustrated, if one of the services offered by the mobile terminal or a service by a malware attempts to process an unauthorized event by using a fake secure key, the modem processing unit 300 may extract the fake secure key value from the event and determine that the event may not be processed since the extracted secure key value fails to match the stored secure key value.

Even if the extracted secure key value does not match the secure key value that is set with respect to the SMS service or the MMS service, the modem processing unit 300 may receive verification from a user about whether to execute the requested service or operation. If the user verifies that APP1 is an appropriate application to execute the requested service or operation, the modem processing unit 300 may process the event. Further, a secure key value may be generated for the verified operation and set or assigned to the respective application.

If the user does not verify that APP1 is an appropriate application to execute the corresponding service or denies execution of the event, the modem processing unit 300 may not process the event.

APP2 and APP3 may also operate in a similar manner based on whether a secure key value is set to a corresponding service.

FIG. 3 is a block diagram illustrating a modem processing unit according to an exemplary embodiment of the present invention.

Referring to FIG. 3, the modem processing unit 300 may include an event receiver 310, a key parsing unit 320, an event processing unit 330, and a modem database (DB) 340.

The event receiver 310 may receive an event related to an application that may be received from an application frame layer.

If a key value is present in the event received by the event receiver 310, the key parsing unit 320 may extract a secure key value by decoding data transformed to external data representation (XDR).

The event processing unit 330 may process the event based on a comparison result of a key comparison unit 342 of the modem database 340. If the secure key value is absent, or if the secure key value does not match a secure key value that is set to a corresponding application service, the event processing unit 330 may provide a user interface to receive a user input. A user may determine whether to allow the requested service by providing a corresponding user input.

The modem database 340 may include a secure key storage unit 341 and a key comparison unit 342.

The secure key value storage unit 341 may store a secure key value that may be used per operation rather than an application, that is, a reference secure key value may be used for one or more application executing the respective operation.

The key comparison unit 342 may compare a secure key value corresponding to an event and a secure key value stored in the modem database 340. The key comparison unit 342 may verify whether the secure key value is present in an event transferred to the key value parsing unit 320. If the secure key value is present, the key comparison unit 320 may determine whether a value of the parsed secure key value matches or corresponds to a value of the secure key value stored in the secure key storage unit 341. The key comparison unit 342 may transmit corresponding result information to the event processing unit 330 based on the comparison result.

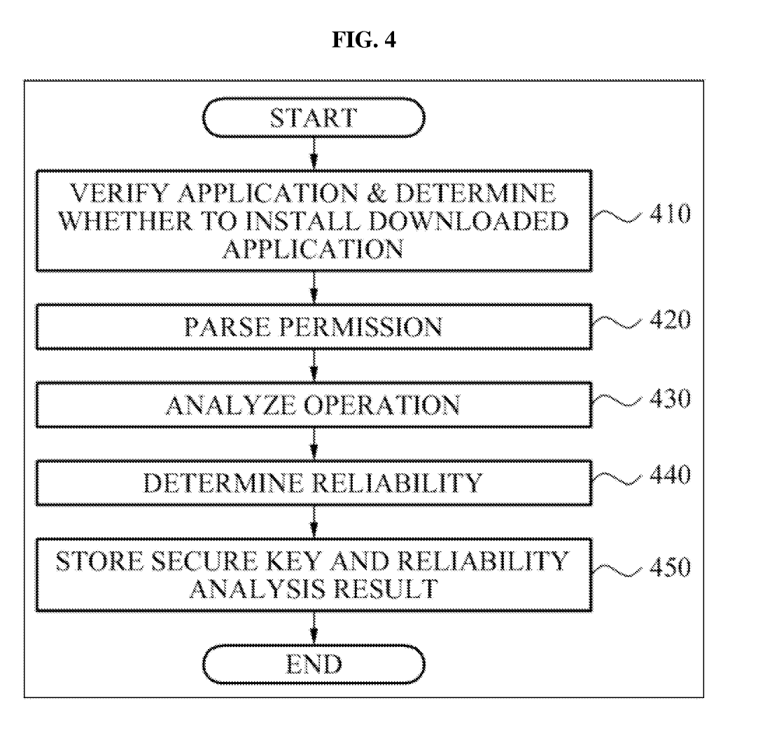

FIG. 4 is a flowchart illustrating a method for downloading an application according to an exemplary embodiment of the present invention.

The method for downloading the application as described in FIG. 4 will be described as if the method is performed by the apparatus of FIG. 2, but is not limited thereto.

Referring to FIG. 4, the application of the mobile terminal may be classified into a default application that may be installed when the smart device is manufactured, or a new application that is installed based on a user selection or action (e.g., downloading of an application from a third party website).

In operation 410, the installation determining unit 210 of the application processing unit 200 may verify an application downloaded from a communication network or received from an outside source. Further, the installation determining unit 210 may determine whether to install the downloaded application.

In operation 420, if the downloaded application is determined to be installed, the is application operation parsing unit 220 may parse access rights information or permission of the application to access one or more operations.

Table 3 shows an example of the parsed right information.

TABLE 3
ACCESS_NETWORK_STATE: Allows applications to access
information about networks
INTERNET: Allows applications to open network sockets
NFC: Allows applications to perform input/output (I/O) operations
over near-field-communication (NFC)
ACCESS_FINE_LOCATION: Allows an application to access fine (e.g.,
global positioning system (GPS)) location or physical location
information of the mobile terminal
BROADCAST_SMS: Allows an application to broadcast an short
message service (SMS) receipt notification
CALL_PHONE: Allows an application to initiate a phone call
without going through a dialer user interface for the user to
confirm the call being placed.

In operation 430, the application operation parsing unit 220 may analyze an operation of the application based on the parsed access rights information. For example, operations, such as a phone call, a message (e.g., SMS or MMS), and the like, may be included in the access rights information of the application.

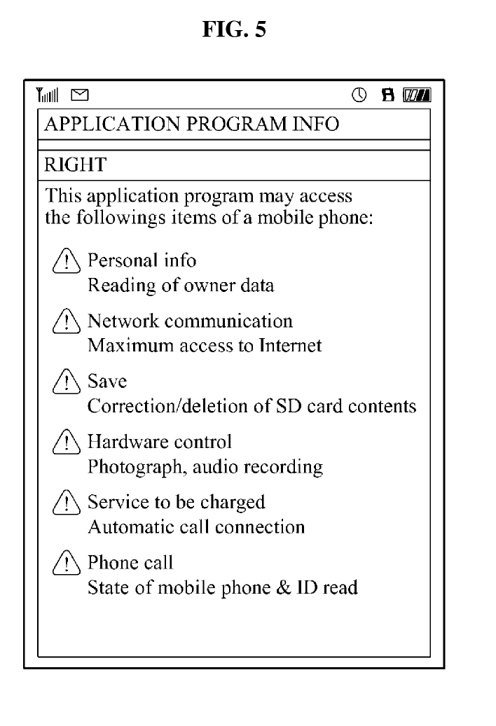

Access rights information may include access information to a variety of items or information by an application, which may be based on the operation of the application, as disclosed in FIG. 5.

FIG. 5 is a diagram illustrating an access right search result of an application according to an exemplary embodiment of the present invention.

Referring to FIG. 5, the application may include access rights information according to a corresponding operation. Access rights information may refer to one or more operations of an application authorized or allowed by the mobile terminal. As shown in FIG. 5, items, such as a reading of personal information, network communication, storage of data, control of hardware, applying of service charge, setting call switching, system tools, and the like, may be included based on an operational characteristic of the application.

Table 4 shows an example of an operation analysis result of the application.

TABLE 4
Phone call: Automatic call connection, automatic call receiving
Message: SMS/MMS transmission, automatic reading of SMS/MMS
Network communication: Access to the Internet
Location: Verification of approximate/detail location information based on
network
Personal information: Reading of contact data, writing of contact data
Account: Account list management, account authentication data activity,
use of account authentication certificate
System tools: Writing of synchronization setting, searching of application
being executed, correction of overall system setting, setting portable
phone to not be switched to power saving mode
Control of hardware: Audio recording, change of audio setting

In operation 440, the application reliability determining unit 230 may determine a reliability of the application based on the operation analysis result that is analyzed in operation 430.

The application reliability determining unit 230 may monitor and/or analyze executed operations, such as charging according to an operation of the application, invasion of user privacy, and the like. The application reliability determining unit 230 may provide the application analysis result to the user, or may store the application analysis result in the database 250.

Table 5 shows an example of the reliability decision result.

TABLE 5

Transmitting/receiving of call undesired by user
Transmitting/receiving of SMS/MMS undesired by user
Transmitting of location information undesired by user
Leakage of device information undesired by user
Leakage of personal information undesired by user
Remote device control undesired by user

In operation 450, the secure key value storage unit 252 may store the reliability analysis result determined in operation 440 and a secure key value with respect to each operation of the mobile terminal. Table 6 shows an example of the reliability analysis result stored in the database 250.

TABLE 6

| APP ID | Reliability Level | Possible Risks |
|---|---|---|
| A | ★(Very low) | Transmitting/receiving of call undesired |
| | | by user |
| | | Transmitting of location information |
| | | undesired by user |
| | | Leakage of personal information undesired |
| | | by user |
| | | Remote device control undesired by user |
| B | ★★ (Low) | Transmitting/receiving of call undesired by |
| | | user |
| | | Transmitting of location information |
| | | undesired by user |
| | | Leakage of personal information undesired |
| | | by user |
| C | ★★★(Average) | Transmitting of location information |
| | | undesired by user |
| | | Leakage of personal information undesired |
| | | by user |
| D | ★★ (Low) | Transmitting/receiving of call undesired by |
| | | user |
| | | Transmitting of location information |
| | | undesired by user |
| E | ★★★★★ | No major risks |
| | (Very high) | |

As shown in Table 6, a reliability level of the application may be determined based on the number of possible risks according to an operation of the application. In the case of an application with an APP ID “A”, the number of possible risks may be larger in comparison with respect to other applications and thus, a reliability level of the application may be set as “very low”.

In addition, the reliability level determined by the application reliability determining unit 230 may be analyzed based on a variety of information, such as operation of the application, supplier or manufacturer of the application, number of downloads thereof, downloaded path, release date thereof, and the like.

Even if the number of possible risks of a reference application is small, a reliability level of the reference application may be evaluated as having “low” reliability level if a credit level of a supplier is low.

The reliability analysis result may be provided to the user. The reliability analysis result may be stored in the database 250 for a case where the reliability level of the application is to be verified.

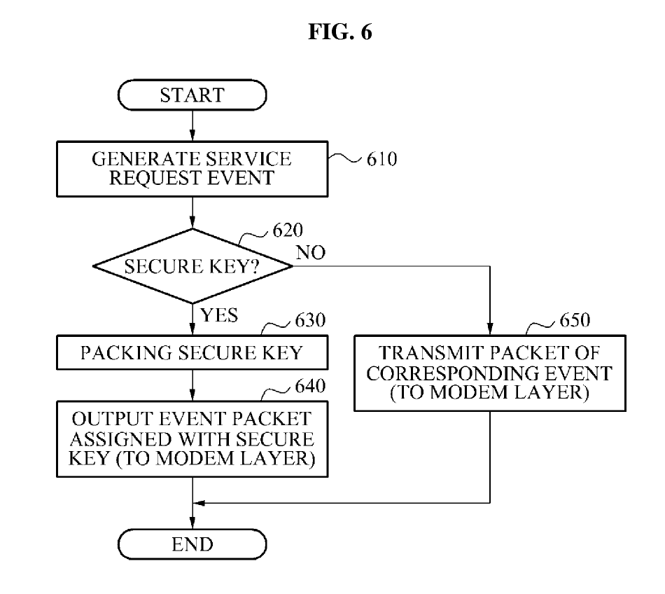

FIG. 6 is a flowchart illustrating a method for generating a service request event in response to an execution of an application according to an exemplary embodiment of the present invention.

The method for generating the service request event as described in FIG. 6 will be described as if the method is performed by the apparatus of FIG. 2, but is not limited as such.

An example of assigning, by a framework layer of a mobile terminal, a secure key value to data related to call originating according to a corresponding service type if an application desired or undesired by a user is executed will be described with reference to FIG. 6, but is not limited as such. In addition, determining whether to execute the application will also be described with reference to FIG. 6, but is not limited as such.

In operation 610, if a service behavior event occurs due to the application, the framework layer may generate an event for the requested service and may output a corresponding event value to the application management storage unit 253.

In operation 620, the application management storage unit 253 may determine whether a secure key value is set with respect to the generated event that has occurred for a reference charging behavior of a stored application.

In operation 630, if the secure key value corresponding to a service type of the application is determined to be assigned, the application processing unit 253 may add the secure key value to data related to call origination or the event and thereby pack the secure key value in the event.

In operation 640, a packed event packet including the secure key value may be output to the modem processing unit 300.

If the secure key value corresponding to the service type is absent in the database 250, the application processing unit 253 may output a packet of the corresponding event without the secure key value to the modem processing unit 300 in operation 650.

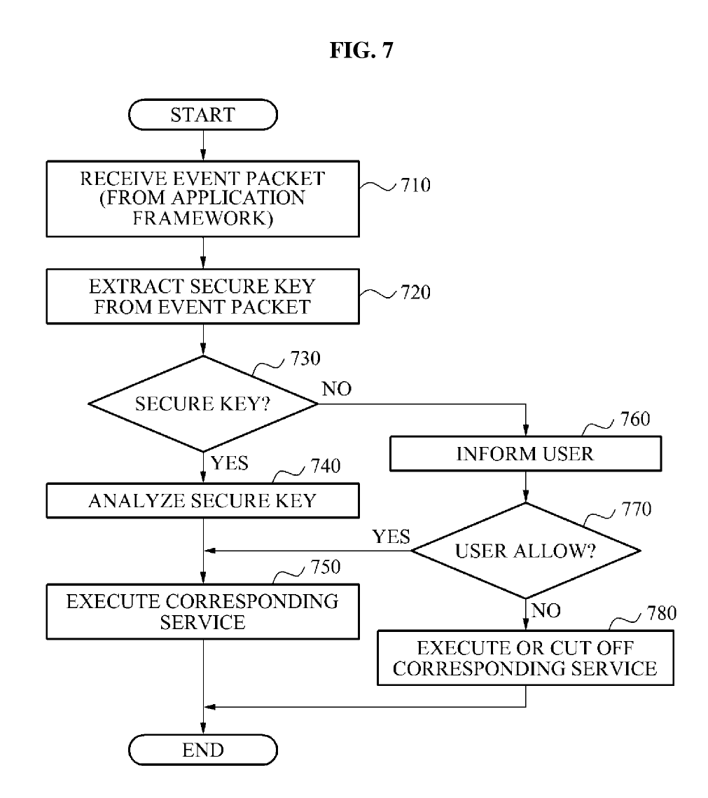

FIG. 7 is a flowchart illustrating a method for operating a modem processing unit according to an exemplary embodiment of the present invention.

The method for operating the modem processing unit as described in FIG. 7 will be described as if the method is performed by the apparatus of FIG. 3, but is not limited as such.

Referring to FIG. 7, in operation 710, the modem processing unit 300 may receive an event packet from the application processing unit 200 of the application framework 20.

In operation 720, the modem processing unit 300 may extract a secure key value from the event packet. The secure key value may be extracted by decoding data transformed to XDR.

In the extraction method of the secure key value, a size corresponding to a message size of a secure key value parameter, may be included in an XDR decoding format of the modem processing unit 300. The secure key value parameter may be defined as an XDR format with respect to the data. Thus, if receiving the data, the secure key value may be decoded.

In operation 730, the modem processing unit 300 may determine whether the secure key value is present based on the extraction result of the secure key value from the event packet.

In operation 740, if the secure key value is extracted from the event packet, the modem processing unit 300 may determine whether the secure key value is accurate, by referring to a secure key value table.

In operation 750, the modem processing unit 300 may output a service execution signal of a corresponding application based on the analysis result of the secure key value.

If the extracted secure key value is absent in operation 730, the modem processing unit 300 may inform the user about corresponding information in operation 760.

In operation 770, in the case of the service event packet that does have the secure key value, a selection or input on whether to execute the corresponding service may be received from the user.

In operation 780, the modem processing unit 300 may receive the selection or input from the user and thereby execute or cut off the corresponding service.

According to exemplary embodiments of the invention, an apparatus and method for managing access rights of an application in a mobile terminal may limit unauthorized execution of an application, and may thereby reduce a possible risk of receiving charges or gathering of personal information of the user.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal to execute an operation of an application, comprising:
an application layer to store the application;
an application framework to determine a reliability level of the application, to assign a first secure key value to the operation, and to pack a second secure key value to an event packet generated by the application; and
a modem layer to extract the second secure key value from the event packet, to determine whether the second secure key value corresponds to the first secure key value of the operation, and to determine whether to execute the operation.

2. The mobile terminal of claim 1, wherein the application framework further determines whether to install the application based on the reliability level of the application.

3. The mobile terminal of claim 1, wherein the application framework further comprises:
an application installation determining unit to determine a type of the application;
an application operation parsing unit to parse information associated with the application, and to determine the operation of the application based on the parsed information;
an application reliability determining unit to determine the reliability level of the application based on the parsed information; and
a key value packet processing unit to process the event packet if the first secure key value corresponds to the second secure key value.

4. The mobile terminal of claim 3, wherein the parsed information comprises at least one of the type, an operational characteristic, and the operation of the application.

5. The mobile terminal of claim 1, wherein the reliability level is based on at least one of a type, an operational characteristic, and the operation of the application.

6. The mobile terminal of claim 3, further comprising a database to store at least one of the reliability level of the application, the operation of the application, and the first secure key value.

7. The mobile terminal of claim 1, wherein the second secure key value is extracted by decoding data transformed to external data representation (XDR).

8. The mobile terminal of claim 1, wherein the modem layer further receives a user input to execute the operation if the second secure key value does not correspond to the first secure key value.

9. The mobile terminal of claim 8, wherein the application framework generates a third secure key value to be assigned to the operation corresponding to the received user input.

10. A method for executing an operation of an application, comprising:
assigning a first secure key value to the operation;
receiving an event packet corresponding to the operation;
extracting a second secure key value from the event packet;
comparing the second secure key value with the first secure key value; and
determining whether to execute the operation.

11. The method of claim 10, wherein determining whether to execute the operation comprises executing the operation if the second secure key value corresponds to the first secure key value.

12. The method of claim 10, further comprising:
receiving a user input for executing the operation if the second secure key value does not correspond to the first secure key value.

13. The method of claim 12, further comprising:
assigning a third secure key value to the operation corresponding to the received user input.

14. The method of claim 10, further comprising:
determining a reliability level of the application; and
packing the second secure key value to the event packet generated by the application.

15. The method of claim 14, wherein the reliability level is based on at least one of a type, an operational characteristic, and the operation of the application.

16. The method of claim 14, further comprising determining whether to install the application based on the determined reliability level of the application.

17. The method of claim 14, further comprising:
determining a type of the application;
parsing information associated with the application;
determining the operation of the application based on the parsed information;
determining reliability level of the application based on the parsed information; and
processing the event packet if the second secure key value corresponds to the first secure key value.

18. The method of claim 10, wherein the second secure key value is extracted by decoding data transformed to external data representation (XDR).

19. A method for installing an application, comprising:
determining a type of the application;
determining an operation of the application;
determining a reliability level of the application;
installing the application;
assigning the operation to the application based on the reliability level; and
assigning a first secure key value to the operation.

20. The method of claim 19, wherein the reliability level is determined based on at least one of a number of risks associated with executing the application, the operation of the application, a manufacturer of the application, a number of downloads of the application, a download path, and a release date of the application.
